(19) United States
(12) Patent Application Publication
(10) Pub. No.: US 2015/0072081 A1
(43) Pub. Date: Mar. 12, 2015

(54) EXTERNAL COATING METHOD AND APPARATUS

(71) Applicants: Ryan Winston Monchamp, San Tan Valley, AZ (US); Peter Paul Roosen, Wellington (CA)

(72) Inventors: Ryan Winston Monchamp, San Tan Valley, AZ (US); Peter Paul Roosen, Wellington (CA)

(21) Appl. No.: 14/023,311

(22) Filed: Sep. 10, 2013

(51) Int. Cl. B05B 3/10; B05B 7/00; B05B 3/02; B05D 1/02; B05D 5/00

(52) U.S. Cl. CPC B05B 3/1064; B05D 1/02; B05D 5/00; B05B 3/02; B05B 7/0018
USPC 427/427.3; 239/264

(57) ABSTRACT

An apparatus for and method of coating the external surfaces of slender non-rotating members such as pipe, tube, rebar, wire, cable, coil springs, angle, channel, sheets, strips or bars as they are moving longitudinally through the coating apparatus with a fluid using a single-port or multi-port rotary union and one or more spraying orifices. The apparatus further includes the ability to apply either single component or plural component coatings to said non-rotating, moving members. Said coatings can include various types of paints, varnishes and thermoplastic or thermosetting single component or plural component coating products. Said plural component coating products can be made from urethanes, ureas, epoxies, polyesters, phenolics and other chemical compositions that react rapidly upon mixing of the components thereof. Said coatings can also include foam materials. Said fluid can be in liquid or powder form.

### BACKGROUND OF THE INVENTION

The present invention relates to coating apparatus and methods for coating the external or outer surfaces of non-rotating members with a fluid.

Coating slender members such as pipe for corrosion protection, improved aesthetic qualities and other reasons is typically accomplished by either manually spraying single component or plural component fluid coating materials onto the member or by rotating such members as they are conveyed past one or more spraying orifices in a more automated process. In the automated processes, the spraying orifices are normally held in a fixed position.

The coating fluid can be either a single or plural component liquid or it can be in the form of a particulate thermosetting powder which fuses to a heated substrate.

In the case of long tubes, wires or cables, that are difficult or impossible to rotate as they are transported, it is a common practice to extrude thermoplastic or thermosetting materials onto the surface of the member being coated. Cables are often manufactured using a stepwise process of coating individual wire strands or multi-strand wires by extrusion means, then later coating a group of them using a similar extrusion process to form the cable.

There are several disadvantages associated with the above traditional approaches.

For spray-applied coatings, the conveying system used to rotate and advance the member is difficult and expensive to construct and maintain. Members being fed from spools or coils usually cannot be rotated unless the payout spool or coil and the corresponding take-up spool or coil are also able to rotate to prevent twisting the member.

Especially in the cases of small diameters or sizes of members being coated, if the member is not rotated, it is difficult to achieve a uniform coating and there is often a great deal of material wastage from over-spray. This problem has generally been overcome in the case of low viscosity paints, varnishes, etc which employ solvents because the over-spray material can often be captured and re-introduced to the process, greatly reducing such wastage. Unfortunately, the tendency toward using coating materials that do not employ solvents and those that are plural component thermosetting materials has been making it increasingly difficult to employ such recycling strategies.

The extrusion process normally does not require the member being coated to be rotated, however, extrusion equipment is often very expensive to construct and is limited to relatively few coating materials, mainly thermoplastic ones, due to the various technical constraints imposed by the extrusion process itself.

Spray applied plural component thermoplastic and thermosetting materials have gained wide commercial acceptance as protective and decorative coatings. Similarly, spray applied foams are in widespread use throughout the world. There is a large body of prior art with respect to these types of materials that usually come as two part formulations in which the respective parts chemically combine into finished form once dispensed from the spray application system. The cure rates and gel times vary widely for the various formulations from several hours to less than 10 seconds. In many formulations, the rates can be modified through the use of varying temperatures, types and amount of catalysts and other means.

Plural component formulations occasionally come in 3, 4 or more parts but this is not the norm with the vast majority of plural component systems being two part systems. The respective components of a plural component system are often identified as a Part A and Part B respectively, with additional Part C, Part D, etc. in instances where there are more than the typical two fluid components involved. For purposes of this disclosure, the typical two part system and nomenclature will be used throughout although the applicants' intention is to not limit the scope of disclosure and claims to only two component systems by doing so. It is an accepted well known practice to introduce catalysts (accelerators), blowing agents, coloring agents, etc. as separate components in a plural component system rather than pre-blending such ingredients into one of the fluid components of a plural component system. However, describing these more complex systems can become cumbersome, particularly in the drawings, so the applicants respectfully ask readers to consider a plural component system as being defined herein as a formulation that comes in two or more parts.

Many formulations employ solvents in varying types and amounts either within the formulations themselves or to clean and purge some or all of the equipment components of the spraying systems known in the prior art. U.S. Pat. No. 4,695,618, issued to Norman R. Mowrer in 1987, discloses that a then “growing emphasis on compliance with government environmental and health regulations that limit both the type and amount of volatile organic compounds (VOC) has prompted coating manufacturers and end users to evaluate new coating technologies” (Column 1, Row 40-44). Since that time, manufacturers have produced an increasing number of formulations that are described in the art as being as much as 100% solids—a terms used to describe the percentage of the ingredients that remain in the formulations after completion of the cure cycle. This confirms there has in fact been a long felt need to reduce or eliminate the use of said solvents and other volatile components from formulations and also from equipment purging and cleaning processes.

Manufacturers of formulations and equipment respectively are having difficulties developing new technologies that meet the tightening environmental and health requirements while meeting customer and end user demands for better solutions without increasing costs. In particular, eliminating the use of solvents has made it much more difficult to develop improved formulations that maintain 1:1 volumetric ratios with matched viscosities. The trend has been toward formulations that have widening ratios with 4:1 currently considered the maximum viable ratio. It is desired to have spraying systems that go beyond this to accommodate in excess of 10:1 for some formulations. Generally, the widely held perception is that the further a ratio moves from 1:1, the more difficult it becomes to successfully mix and dispense the material. Viscosities are similarly becoming more divergent, generally increasing, with formulations known in the art that have viscosities increasing to as much as 1,000,000 CPS (centipoises). In comparison, other materials have much lower viscosities, as little as 50 CPS. It has therefore become a common practice to include elaborate heating systems to decrease the viscosity of thick materials such that they can be successfully pumped, mixed and dispensed using spraying technology.

U.S. Pat. No. 5,344,490, issued to Peter Paul Roosen et al. in 1994, discloses a plasticised gypsum composition that includes plural component formulations that have volumetric ratios ranging between 4:1 to 9:1 and large differences in viscosity between the respective Part A and Part B components. Roosen is one of the applicants herein and the disclosure of the '490 patent is incorporated herein by reference. Roosen '490 formulation Example 1 is for a plural component gypsum composition that contains 41% PBW (parts by weight) gypsum in total and is typically prepared in two parts with Part A being the gypsum and various other ingredients totalling 83% PBW and Part B being the balance 17% isocyanate. This 5:1 PBW ratio translates to a volumetric ratio of approximately 4.5:1 which is not a standard industry ratio and has therefore been difficult to dispense by means of a solvent-free spray application using conventional off the shelf equipment. US 2013/0015262, of the inventors herein (Monchamp and Roosen), which is hereby incorporated by reference herein, describes a solvent-free plural component spraying system and method that has been successfully applying the above Roosen '490 formulation to various substrates, including pipes and other slender members such as those of the present invention through a traditional manual approach.

A rotary union is an increasingly common means of transporting one or more fluids at a time along multiple conduits at various temperatures and pressures without cross contamination while still allowing for relative rotation between incoming and outgoing conduits. Fluids typically used with rotary unions include various heat transfer media and fluid power media such as steam, water, thermal oil, hydraulic fluid, and coolants. Rotary unions appear in automobiles and other machines that require constant supplies of lubrication, air, or other liquids in order for moving parts to run smoothly. Brakes, for example, use rotary unions to maintain a constant supply of pressurized brake fluid. Rotary unions are also used in crude oil processing, the chemical industry, commercial food production, and pharmaceutical applications. See, e.g., US 2005/0046181.

There are several designs of rotary unions described in the prior art. See, e.g., U.S. Pat. No. 5,538,292, US 2008/0302994, which are hereby incorporated by reference herein. They are typically comprised of two main components, a rotor and a stator that are each respectively made from a single piece of material. There are, however, rotary unions that are made with multi-stage rotors and multi-stage stators in which the number of fluids that can be transported is determined by the number of stages that are employed. Among the rotary unions that are presently commercially available, some include a large axial bore.

Rotary unions are increasingly becoming better able to withstand fluid pressures in excess of 3500 psi, with some in excess of 7000 psi. Maintaining leak-free sealing arrangements to prevent cross-contamination between the flowing fluids and to prevent fluids from escaping to the environment has always proven challenging, especially in the case of larger diameter rotary unions. At present, these devices are limited to a practical maximum rotor diameter of approximately 36 inches (90 cm). As the sizes increase, the ability to withstand higher operating pressures tends to decrease.

U.S. Pat. No. 5,141,774, is directed to an internal coating apparatus in which fluid is pumped into a rotating hollow probe which is moved upward into an internal cavity of an object to be coated, whereby fluid is dispersed onto the surface of the internal cavity by the centrifugal force of the rotary motion of the probe.

### OBJECTS OF THE INVENTION

Rather than follow the current trend toward having the formulations engineered to suit the perceived equipment limitations such as in the case of extrusion coatings, the applicants are taking the opposite approach by inventing a solvent-free spraying system and engineering the methods and apparatus to accommodate a much wider range of formulation variations. One object of the invention is to facilitate the continuing trend toward reduced use of solvents within the formulations while also striving to eliminate the need to use solvents to purge and clean the coating system equipment.

Another objective is to provide a spray system that allows formulators to successfully mix and disperse a much wider range of products than the industry is currently accustomed to. For instance, a spray system which can readily and reliably handle a wide range of ratios and a large difference of viscosities and pressures between respective part A and part B of a two component formulation, would be expected to be of considerable value to formulators, their customers and end users alike.

A very important object of the invention is to enhance the ability to provide uniform coatings while minimizing wastage due to over-spray.

### SUMMARY OF THE INVENTION

The present invention is directed to providing uniform coatings to the external or outer surfaces of slender members such as pipe, tube, rebar, wire, cable, coil springs, angle, channel, sheets, strips or bars as they are moving longitudinally through the coating apparatus with a fluid using a single-port or multi-port rotary union and one or more spraying orifices. The coating apparatus operates without the need to rotate the member as it passes through said apparatus.

The apparatus further includes the ability to apply either single component or plural component coatings to said non-rotating, moving members. Said coatings can include various types of paints, varnishes and thermoplastic or thermosetting single component or plural component coating products. Said plural component coating products can be made from urethanes, ureas, epoxies, polyesters, phenolics and other chemical compositions that react rapidly upon mixing of the components thereof. Said coatings can also include foam materials. Said fluid can be in liquid or powder form.

When describing the present invention, all terms not defined herein have their common art-recognized meanings.

Further features of the invention may become apparent to those skilled in the art from a review of this summary and the following detailed description, taken in combination with the appended claims and drawings. While the invention is susceptible of embodiments in various forms, described hereinafter are specific embodiments of the invention with the understanding that the present disclosure is intended to be illustrative, and is not intended to limit the invention to the specific embodiments described herein.

The drawings and more detailed description of the preferred embodiment that follow comprises one example of the invention. Other embodiments of the invention will be apparent to those skilled in the art from the drawings and more detailed description that follows.

### BRIEF DESCRIPTIONS OF THE DRAWINGS

FIG. 1 is a perspective view of the assembled external coating apparatus according to a presently preferred embodiment of the invention;

FIG. 2 is a section view thereof;

FIG. 3 is an exploded section view thereof;

FIG. 4 is an enlarged perspective view of the housing of the apparatus;

FIG. 5 is an enlarged section view of the housing of the apparatus;

FIG. 6 is an enlarged perspective view of the shaft of the apparatus;

FIG. 7 is an enlarged section view of the shaft of the apparatus;

FIG. 8 is an enlarged perspective view of the hub of the apparatus;

FIG. 9 is an enlarged section view of the hub of the apparatus; and

FIG. 10 is an enlarged perspective view of a preferred spray gun, with adjustment and mounting bracket, of the apparatus.

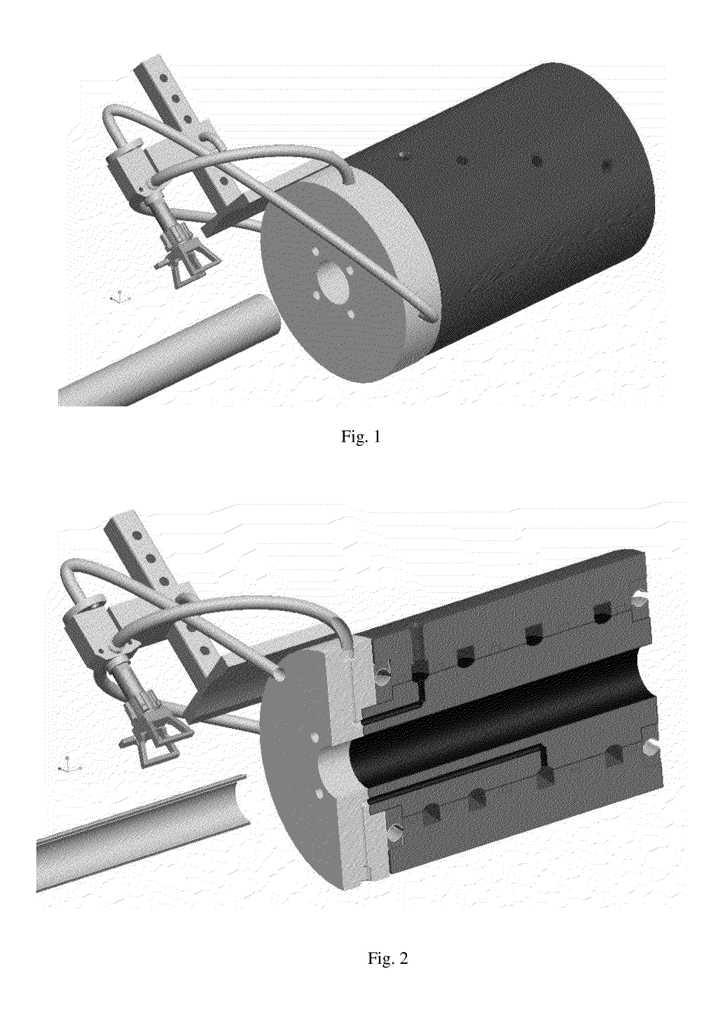

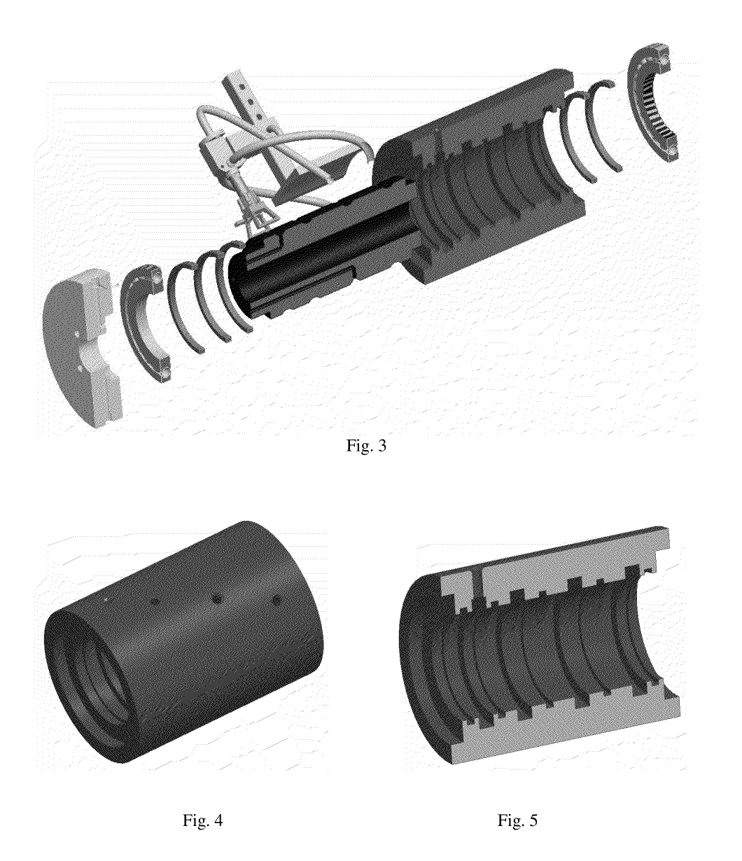

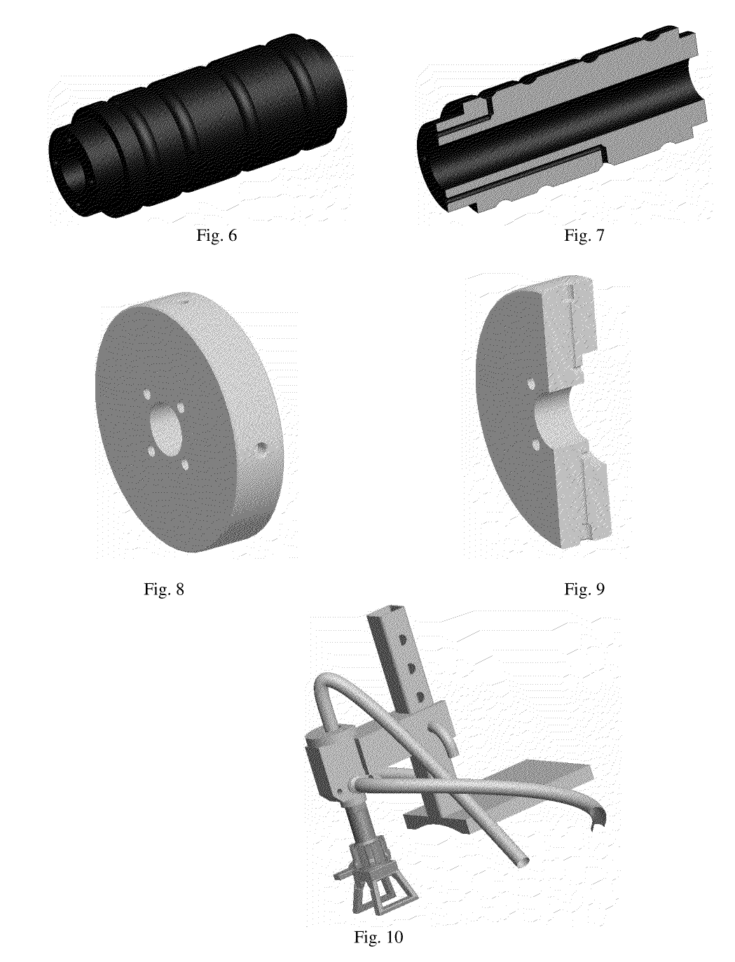

### DETAILED DESCRIPTION OF THE CURRENTLY BEST KNOWN MODE OF THE INVENTION

The apparatus of the invention features a hollow rotary union 1 through which a member to be coated 2 can be transported longitudinally. That is, the rotary union has an axial bore 3. Pressurized fluid component(s) is/are supplied to the stationary portion 4 of the rotary union by a pump or otherwise. A spraying orifice 5, which is preferably part of a spray gun 6, most preferably the spray gun described in US 2013/0015262, is attached to the rotating portion 7 of the rotary union. Preferably, this attachment is made by way of a mounting bracket 8 and an adjustment bracket 9. The adjustment bracket allows the radial position of the orifice 5 to be adjusted relative to the axis of rotation of the rotating portion 7 of the rotary union, and thereby relative to the member to be coated 2. The apparatus may be configured to be used with any number of fluid components, but preferably may be used with not more than 4, and most preferably with 2, components. This may be achieved either by using a rotary union with the desired number of ports 10, or by using a rotary union with more than the necessary number of ports, but only using the desired number of ports. The rotary union also preferably has an air or flushing port 11. The port(s) 10 communicate with the orifice 5, preferably via the spray gun 6, so that the fluid component(s) may be coated on the member 2. The apparatus may also be configured with more than one orifice 5 and spray gun 6.

The invention also relates to a method for coating members 2 with the apparatus. While passing the member 2 through the axial bore 3 of the rotary union 1, the orifice 5 rotates with the rotating part 7 of the rotary union 1. This passing through the axial bore 3 may be effected either by moving the member 2 or by moving the apparatus. In other words, the member can be moved longitudinally through the apparatus or the apparatus can be moved along the length of the member. Preferably, the rotating part 7 is rotated and a constant rate and/or the velocity of the member 2 relative to the apparatus is constant during spraying. In this way, the member 2 is coated evenly and without material waste. Moreover, a wide array of types of members can be coated, including those being fed by spools or coils. In a preferred embodiment, a plural component formulation is applied where the volumetric ratio of any two of the components may be greater than 4:1., or even 10:1.

Accordingly, the invention advantageously and efficiently enables uniform coating of slender members, without the need to rotate such members. The invention overcomes the difficulty of coating members being fed from spools or coils which cannot be easily rotated. Moreover, the invention advantageously avoids material wastage from overspray, and further avoids the need for using and recovering solvents which may be used in such overspraying applications, thereby reducing environmental disadvantages associated with such solvent use. The invention is particularly advantageous in applying thermosetting materials, preferably plural component thermosetting materials, where once the components are mixed and/or begin to cure, it is difficult to recover or recycle them. The invention can further advantageously be used to coat or recoat existing pipelines which may be fixed in position.

While the invention has been disclosed in its preferred form, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein. No single feature, function, element, or property of the disclosed embodiments is essential. The following claims define certain combinations and subcombinations which are regarded as novel and non-obvious. Other combinations and subcombinations of features, functions, elements, and/or properties may be claimed through amendment of the present claims or presentation of new claims in this or a related application. Such claims also are regarded as included within the subject matter of the present invention irrespective of whether they are broader, narrower, or equal in scope to the original claims. This invention also covers all embodiments and all applications which will be immediately comprehensible to the expert upon reading this application, on the basis of his or her knowledge and optionally simple routine tests.

We claim:

1. An apparatus for coating an outer surface of a non-rotating member with a fluid comprising:
a hollow rotary union through which said member can be transported longitudinally;
a stationary portion of said rotary union which receives a supply of pressurized fluid;
one or more spraying orifices attached to a rotating portion of said rotary union which can rotate about the member being coated as said member is axially transported through the apparatus,
wherein the fluid is communicated from the stationary portion of the rotary union to the orifice.

2. The apparatus of claim 1, wherein the orifice is part of a spray gun.

3. The apparatus of claim 1, wherein the stationary portion of said rotary union has not more that four ports receiving fluid.

4. The apparatus of claim 4, wherein the stationary portion of said rotary union has an additional air or flushing port.

5. The apparatus of claim 2, further comprising an adjustment bracket to allow the radial position of the spray gun to be adjusted relative to the axis of rotation of the rotating portion of the rotary union.

6. A method for coating a member, said method comprising:
supplying pressurized fluid to the stationary portion of the rotary union of the apparatus of claim 1,
moving the member and apparatus relative to one another such that the member passes through an axial bore of the rotary union,
rotating the orifice along with the rotating part of the rotary union, and spraying the fluid through the orifice onto the member.

7. The method of claim 6, further comprising feeding the member through the rotary union from a spool or coil.

8. The method of claim 6, wherein the fluid comprises a plurality of components.

9. The method of claim 8, wherein the volumetric ratio of at least two of the components is at least 4:1.

10. The method of claim 6, wherein the fluid does not comprise any solvents.

11. The method of claim 6, wherein the fluid contains at least one thermosetting component.

12. The method of claim 6, wherein the fluid contains at least two thermosetting components.

13. The method of claim 12, wherein the components chemically combine into finished form after being sprayed.

14. The method of claim 6, wherein the fluid contains a spray applied foam.

15. The method of claim 6, wherein the member is not rotated while it passes through the axial bore.

16. The method of claim 6, wherein the member has an axis which substantially coincides with the axis of rotation of the rotating portion of said rotary union while the member is passed through the axial bore.
